(19) United States
(12) Patent Application Publication
(10) Pub. No.: US 2007/0046998 A1
(43) Pub. Date: Mar. 1, 2007

(54) Image Processing System, Control Method Therefor, Storage Medium, Image Processing Apparatus, And External Apparatus

(75) Inventor: Shinji Ohnishi, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/468,086

(22) Filed: Aug. 29, 2006

(30) Foreign Application Priority Data
Aug. 30, 2005 (JP) 2005-249949
Sep. 13, 2005 (JP) 2005-265901

(51) Int. Cl. G06K 15/00

(52) U.S. Cl. 358/3.1

(57) ABSTRACT

There is provided an image processing system which includes an image output apparatus which outputs an image-processed image signal and an external apparatus which can display an image output from the image output apparatus such that they can communication with each other. The image output apparatus includes an image processing unit which performs a plurality of image processes on the basis of different image processing parameters transmitted from the external apparatus, and a first transmission unit which transmits, to the external apparatus, a plurality of images processed by the image processing unit for each different image processing parameter. The external apparatus includes a setting unit which sets different image processing parameters, a second transmission unit which transmits the different image processing parameters to the image output apparatus, and a display unit which simultaneously displays a plurality of images transmitted from the image output apparatus.

### BACKGROUND OF THE INVENTION

1. Field of the Invention

The present invention relates to a technique of setting image processing parameters to proper values.

2. Description of the Related Art

Conventionally, there is known an image processing method of performing desired image processing for an original image, and comparing the resultant image with the original image while simultaneously displaying them so as to allow the user to recognize what kind of image processing has been performed. For example, photo retouch software operating on a personal computer (PC) can perform image processing by the following method. Actual image processing can be performed by a method in which, when color correction is to be performed for a still image, the original image and an image obtained by changing the color of the original image by performing image processing using software are displayed side by side to allow the user to select his/her desired color by referring to the displayed images.

There is a prior art in which a layout or the like that displays a plurality of recorded still images side by side is set in the main body of a digital camera to allow the user to make use of the layout in the manner of an electronic album (see Japanese Patent Laid-Open No. 2005-176216).

Conventionally, there are techniques of performing image processing for recorded image data in a PC by using photo retouch software or the like in the above manner, and of layout setting/outputting operation that a PC essentially executes in a digital camera. However, designing either of these techniques allows to perform operation using a PC or camera alone, but does not allow a self-apparatus to execute proper, efficient image adjustment in collaboration with an external device.

With regard to this point, consider an apparatus designed to handle moving images, e.g., a video camera. In this case, since images progress in real time, it is difficult to perform timing adjustment by using the apparatus alone, or the apparatus receives an excessive load when it performs processing alone. For this reason, there may occur a situation in which a better result can be easily obtained by performing image quality adjustment and the like by cooperative operation between apparatuses.

In general, owing to various factors, there are differences in result between a case wherein an image input apparatus performs image quality adjustment and color correction by adjusting parameters and a case wherein software on a PC performs image adjustment with the same purpose for image data acquired from an image input apparatus. In addition, in some case, even image input apparatuses of the same model slightly differ in characteristics. Therefore, image adjustment unique to each image input apparatus is necessary, and hence a desired image can be easily obtained by performing image quality adjustment and the like by cooperative operation between apparatuses.

### SUMMARY OF THE INVENTION

The present invention has been made in consideration of the above problems, and has as its object to easily set image processing parameters in an image input apparatus such as a video camera through an external apparatus by connecting the imaging input apparatus to the external apparatus.

In order to solve the above problems and achieve the above object, according to the first aspect of the present invention, there is provided an image processing system comprising an image output apparatus which outputs an image-processed image signal and an external apparatus which can display an image associated with an image signal output from the image output apparatus such that said apparatuses can communicate with each other, wherein the image output apparatus comprises an image processing unit which performs a plurality of image processes for an image signal to be output on the basis of an image processing parameter transmitted from the external apparatus, and a first transmission unit which sequentially transmits, to the external apparatus, a plurality of image signals image-processed by the image processing unit, and the external apparatus comprises a setting unit which sets the image processing parameter, a second transmission unit which transmits the image processing parameter to the image output apparatus, and a display unit which simultaneously displays a plurality of images associated with the plurality of image signals sequentially transmitted from the image output apparatus on a screen.

A control method for an image processing system according to the second aspect of the present invention is a method of controlling an image processing system comprising an image output apparatus which outputs an image-processed image signal and an external apparatus which can display an image associated with an image signal output from the image output apparatus, comprising a setting step of setting an image processing parameter in the external apparatus, a first transmission step of transmitting the image processing parameter from the external apparatus to the image output apparatus, an image processing step of performing a plurality of image processes for an image signal to be output from the image output apparatus on the basis of an image processing parameter transmitted from the external apparatus to the image output apparatus, a second transmission step of sequentially transmitting a plurality of image signals image-processed in the image processing step from the image output apparatus to the external apparatus, and a display step of simultaneously displaying, on a screen, a plurality of images associated with the plurality of image signals sequentially transmitted from the image output apparatus to the external apparatus.

An image output apparatus according to the third aspect of the present invention is an image output apparatus which can output an image-processed image signal to an external apparatus, comprising an image sensing unit which generates a sensed image signal by sensing an object, an image processing unit which performs a plurality of image processes for the sensed image signal output from said image sensing unit on the basis of an image processing parameter transmitted from an external apparatus which can communicate with the image output apparatus, and a transmission unit which sequentially transmits a plurality of image signals image-processed by the image processing unit to the external apparatus.

An external apparatus according to the fourth aspect of the present invention is an external apparatus which can communicate with an image output apparatus which outputs an image-processed image signal, comprising a setting unit which sets an image processing parameter different from an image processing parameter set in the image output apparatus, a transmission unit which transmits the different image processing parameters to the image output apparatus, and a display unit which simultaneously displays, on a screen, a plurality of images image-processed for each of the different image processing parameters in the image output apparatus which are transmitted from the image output apparatus.

An image processing system according to the fifth aspect of the present invention is an image processing system in which an image transmission apparatus which outputs an image-processed image signal is connected, through a communication path, to an image reception apparatus which can display an image corresponding to an image signal output from the image transmission apparatus, wherein the image transmission apparatus comprises a first reception unit which receives a command from the image reception apparatus, an image processing unit which performs a plurality of image processes on the basis of an image processing parameter included in a command transmitted from the image reception apparatus, and a first transmission unit which transmits a plurality of image signals image-processed by the image processing unit to the image reception apparatus, the image reception apparatus comprises a setting unit which sets the image processing parameter, a second transmission unit which converts an image processing parameter set by the setting unit into a command and transmits the command to the image transmission apparatus, a second reception unit which receives an image signal from the image transmission apparatus, and a display unit which simultaneously displays, on a screen, a plurality of images corresponding to the plurality of image signals transmitted from the image transmission apparatus, and the image reception apparatus further comprises a processing reflection time measuring unit which measures a processing reflection time from the instant the command is transmitted to the instant a corresponding image is detected, and an adjustment unit which adjusts at least one of a transmission timing of the image processing parameter and a display timing of an image on the basis of the processing reflection time.

An image reception apparatus according to the sixth aspect of the present invention is an image reception apparatus which is connected to an external image transmission apparatus through a communication path and can display an image corresponding to an image signal output from the image transmission apparatus, comprising a setting unit which sets an image processing parameter for the image transmission apparatus, a second transmission unit which converts an image processing parameter set by said setting unit into a command and transmits the command to the image transmission apparatus, a second reception unit which receives a plurality of image signals output from the image transmission apparatus in accordance with the command, a display unit which simultaneously displays a plurality of images corresponding to the plurality of image signals transmitted from the image transmission apparatus, a processing reflection time measuring unit which measures a processing reflection time from the instant the command is transmitted to the instant a corresponding image is detected, and an adjustment unit which adjusts at least one of a transmission timing of the image processing parameter and a display timing of an image on the basis of the processing reflection time.

A control method for an image processing system according to the seventh aspect of the present invention is a control method for an image processing system in which an image transmission apparatus which outputs an image-processed image signal is connected, through a communication path, to an image reception apparatus which can display an image corresponding to an image signal output from the image transmission apparatus, wherein a control method for the image transmission apparatus comprises a first reception step of receiving a command from the image reception apparatus, an image processing step of performing a plurality of image processes on the basis of an image processing parameter included in a command transmitted from the image reception apparatus, and a first transmission step of transmitting a plurality of image signals image-processed in the image processing step to the image reception apparatus, a control method for the image reception apparatus comprises a setting step of setting the image processing parameter, a second transmission step of converting an image processing parameter set in the setting step into a command and transmitting the command to the image transmission apparatus, a second reception step of receiving an image signal from the image transmission apparatus, and a display step of simultaneously displaying, on a screen, a plurality of images corresponding to the plurality of image signals transmitted from the image transmission apparatus, and the control method for the image reception apparatus further comprises a processing reflection time measuring step of measuring a processing reflection time from the instant the command is transmitted to the instant a corresponding image is detected, and an adjustment step of adjusting at least one of a transmission timing of the image processing parameter and a display timing of an image on the basis of the processing reflection time.

A control method for an image reception apparatus according to the eighth aspect of the present invention is a control method for an image reception apparatus which is connected to an external image transmission apparatus through a communication path and can display an image corresponding to an image signal output from the image transmission apparatus, comprising a setting step of setting an image processing parameter for the image transmission apparatus, a second transmission step of converting an image processing parameter set in the setting step into a command and transmitting the command to the image transmission apparatus, a second reception step of receiving a plurality of image signals output from the image transmission apparatus in accordance with the command, a display step of simultaneously displaying, on a screen, a plurality of images corresponding to the plurality of image signals transmitted from the image transmission apparatus, a processing reflection time measuring step of measuring a processing reflection time from the instant the command is transmitted to the instant a corresponding image is detected, and an adjustment step of adjusting at least one of a transmission timing of the image processing parameter and a display timing of an image on the basis of the processing reflection time.

According to the ninth aspect of the present invention, a program causes a computer to execute the above control method.

According to the 10th aspect of the present invention, a storage medium is characterized by storing the above program.

Further features of the present invention will become apparent from the following description of exemplary embodiments (with reference to the attached drawings).

### BRIEF DESCRIPTION OF THE DRAWINGS

FIG. 1 is a block diagram showing the arrangements of a digital video camera and a personal computer (PC), which constitute an image processing system according to an embodiment of the present invention;

FIG. 2 is a flowchart showing a sequence of processing executed by software on a PC in an embodiment of the present invention;

FIG. 3 is a flowchart showing detailed processing in an image display step in FIG. 2;

FIG. 4 is a view showing an example of a display window on a display unit in an embodiment of the present invention;

FIG. 5 is a flowchart showing detailed processing in an image selection step in FIG. 2;

FIG. 6 is a flowchart showing an example of a processing sequence executed by software on a PC in the second embodiment of the present invention;

FIG. 7 is a flowchart showing an example of a detailed processing sequence for processing reflection time measurement in step S1205 in FIG. 6;

FIG. 8 is a flowchart showing an example of a detailed processing sequence for image display in step S1206 in FIG. 6;

FIG. 9 is a view showing an example of a display window on a display unit in the second embodiment of the present invention; and

FIG. 10 is a flowchart showing an example of a detailed processing sequence for image selection in step S1207 in FIG. 6.

### DESCRIPTION OF THE EMBODIMENTS

Preferred embodiments of the present invention will be described in detail below with reference to the accompanying drawings.

### First Embodiment

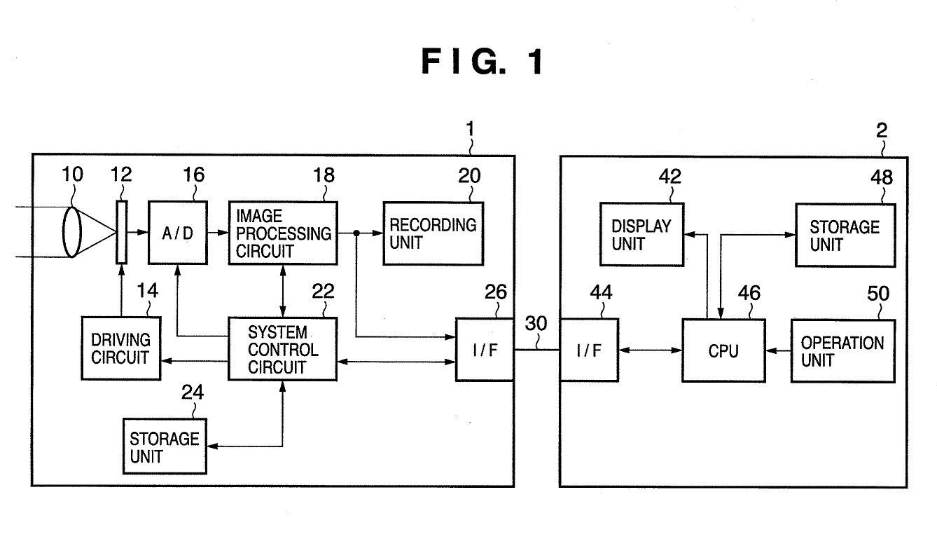

FIG. 1 is a block diagram showing the arrangements of a digital video camera 1 and personal computer (to be referred to as a PC hereinafter) 2 which construct an image processing system according to the first embodiment of the present invention.

Referring to FIG. 1, the digital video camera 1 has the following arrangement. Reference numeral 10 denotes a lens for focusing light from an object; 12, an image sensor for photoelectrically converting the object image formed by the lens 10; 14, a driving circuit for driving the image sensor 12; 16, an A/D converter which converts an analog image signal output from the image sensor 12 into a digital image signal; 18, an image processing circuit which performs image processing for the digital image signal output from the A/D converter 16; 20, a recording unit which records the image-processed digital image signal in a recording medium or the like; 22, a system control circuit which controls the overall digital video camera; and 24, a storage unit which stores an operation program for the system control circuit 22, an image signal under processing, various parameters for image processing, and the like. The storage unit 24 also serves as a work area for the system control circuit 22. Reference numeral 26 denotes a digital interface for allowing the digital video camera 1 to communicate with the PC 2.

Referring to FIG. 1, the PC 2 is a general personal computer and comprises the following components as minimum constituent elements, even though a description thereof will be omitted. Reference numeral 48 denotes a storage unit which stores digital image signals, application software operating on the PC, and the like; 46, a CPU which performs processing in accordance with software stored in the storage unit 48; 42, a display unit such as a liquid crystal display which displays necessary information in accordance with processing by the CPU; 50, an operation unit such as a keyboard, mouse, or the like which is used by a user to input necessary information; and 44, a digital interface which allows the PC 2 to communicate with the digital video camera 1. The digital interfaces 26 and 44 are connected to each other through a cable 30. Note that as the digital interfaces 26 and 44 and the cable 30, wired interfaces such as an IEEE1394 Serial-Bus and a USB, wireless LANs such as an IEEE802.11x, and the like are available.

The image processing system of this embodiment to be described below has an assumption that the PC 2 is connected to the digital video camera 1 through the IEEE1394 cable 30 to construct the system. Software on the PC 2 controls the digital video camera 1.

The IEEE1394 interface performs two types of data transfer, namely isochronous transaction and asynchronous transaction. The real-time transfer of moving image data uses isochronous transaction, whereas the transfer of control signals and the like uses asynchronous transaction. Assume that the digital video camera 1 is outputting video data during recording operation from the IEEE1394 interface 26 by isochronous transaction. Assume also that the PC 2 can adjust a color gain (color strength) as an image processing parameter for the digital video camera 1 by outputting a control signal by asynchronous transaction. In addition, the PC 2 can acquire necessary information from the digital video camera 1 by performing the above asynchronous transaction.

The operation of the image processing system having the above arrangement will be described next.

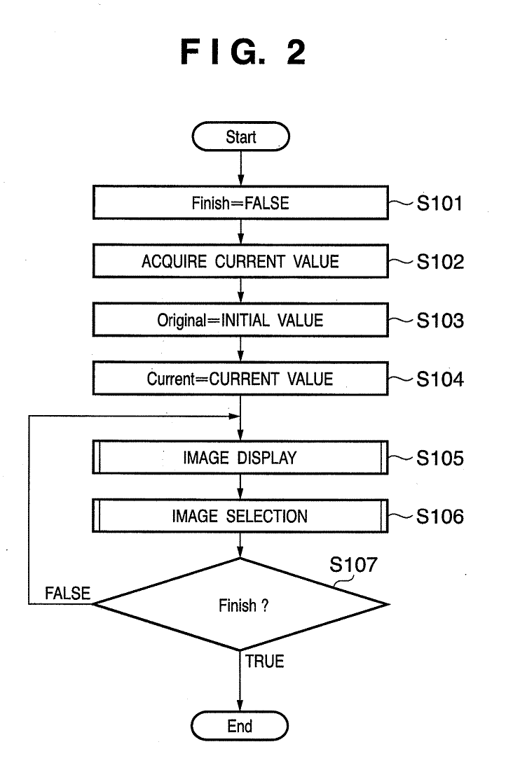

FIG. 2 is a flowchart showing a sequence of processing executed by software on the PC 2 in this embodiment.

First of all, in step S101, “FALSE” is set to the internal variable “Finish”. This variable is a Boolean type variable, which indicates whether image processing operation is complete.

In step S102, the current color gain value set in the digital video camera 1 is acquired. Assume that in this embodiment, the color gain can take integral values from 0 to 12, and as the value increases, color density increases. The acquisition of a color gain value uses asynchronous transaction. Software on the PC 2 transmits an asynchronous packet for the acquisition of a set value to the digital video camera 1. Upon receiving the packet, the digital video camera 1 transmits, to the PC 2, an asynchronous packet set with the current set value of color gain.

In steps S103 and S104, the set value of color gain is read out from the asynchronous packet received from the digital video camera 1, and is set to “Original” and “Current” as internal variables. “Original” holds the set value of color gain at the start of image processing. “Current” holds the current set value of color gain.

In step S105, the PC 2 acquires image data output from the digital video camera 1, temporarily stores it in the storage unit 48, and displays images on the screen of the display unit 42.

In step S106, the user selects an image displayed on the display unit 42 to determine a parameter for image processing. In this case, for example, the images displayed on the display unit 42 are a first image which is processed by using the current set value of color gain in the manner described later, a second image processed with a smaller color gain value, and a third image processed with a larger color gain. That the user selects an image displayed on the display unit 42 means that the user selects one of the first to third images which he/she determines to have a proper color gain value.

In step S107, it is determined whether the image processing operation is complete. If the operation is to continue, the flow returns to step S105 to continue the processing.

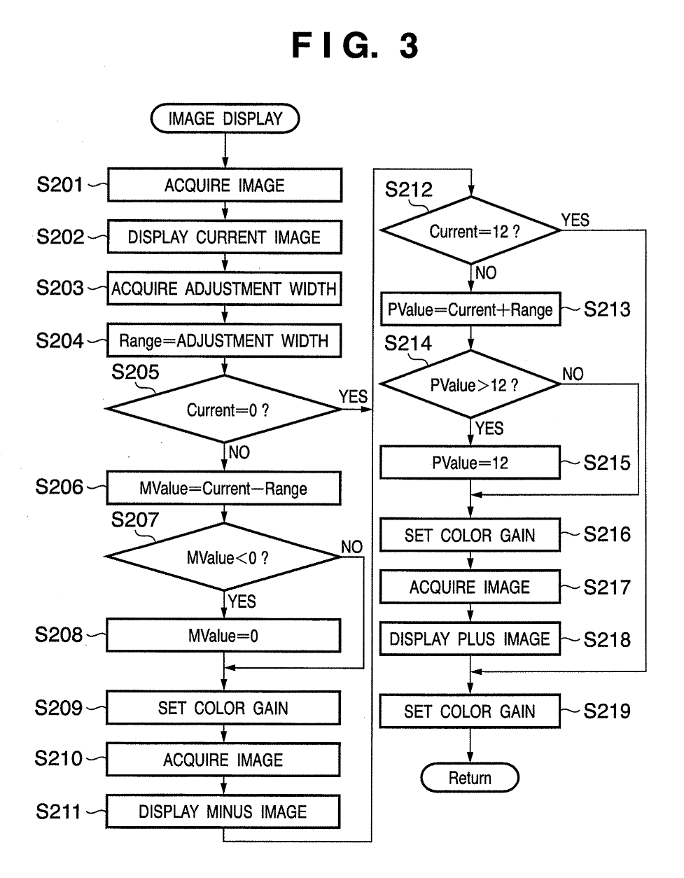

FIG. 3 is a flowchart showing detailed processing in image display step S105 in FIG. 2.

In step S201, the PC 2 captures image data output from the digital video camera 1 with the current set value and temporarily stores the data in the storage unit 48. The image data read out from the storage unit 48 is then displayed on the screen of the display unit 42 in step S202.

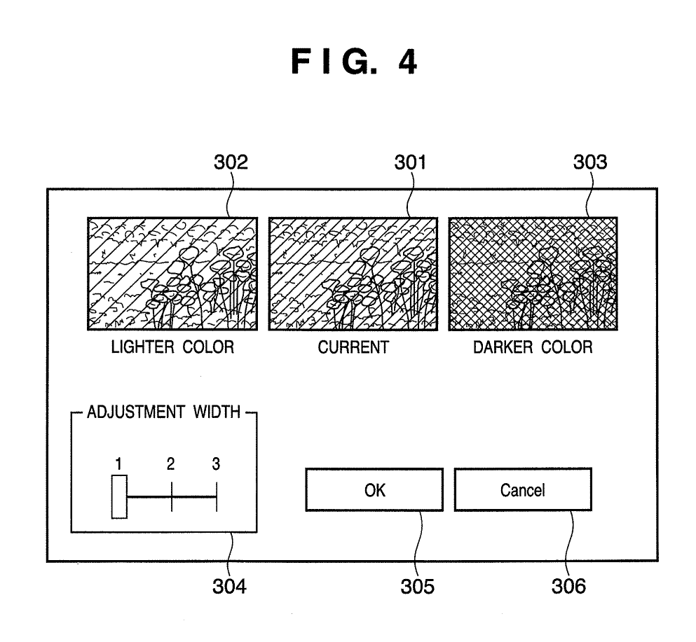

FIG. 4 is a view showing an example of a display window on the display unit 42 in this embodiment. Reference numeral 301 denotes an image with the current set value of color gain.

In step S203, the adjustment width (adjustment amount) of image processing is acquired. Referring to FIG. 4, reference numeral 304 denotes a slider bar for designating an adjustment width. In this embodiment, the user can set an adjustment width between 1 and 3 in this embodiment.

In step S204, the adjustment width (adjustment amount) acquired in step S203 is stored in “Range” as an internal variable.

The display of an image with a set value of color gain smaller than the current set value will be described next.

In step S205, whether the value of “Current” is 0 is determined to discriminate whether the color gain can be set to a value smaller than the current value. If the color gain is 0, since the current value is the minimum value of color gain, the flow advances to step S212 without performing any subsequent processing. If the color gain is a value other than 0, the value obtained subtracting an adjustment width (adjustment amount) from the current set value is set to the internal variable “MValue” in step S206. “MValue” is a set value of color gain smaller than the current set value.

In step S207, it is discriminated whether “MValue” is a minus value. If YES in step S207, 0 as a settable value in the digital video camera is set to “MValue”.

In step S209, an asynchronous packet with the parameter “MValue” is transmitted to the digital video camera 1. Upon receiving the value of “MValue”, the digital video camera 1 sets the value of color gain in the digital video camera 1 to the value set in “MValue”.

In step S210, image data output from the digital video camera 1 with the set value set in step S209 is captured and temporarily stored in the storage unit 48. The image data read out from the storage unit 48 is then displayed as an image whose color gain value is set on the minus side with respect to the current image in step S211. Reference numeral 302 in FIG. 4 denotes an image set on the minus side which is displayed in the above manner.

If minus setting is not performed for the color gain in accordance with the determination result in step S205, a totally black image is displayed as the image 302.

The display of an image with a set value of color gain larger than the current set value will be described next.

In step S212, whether the value of “Current” is 12 is determined to discriminate whether the color gain can be set to a value larger than the current value. If the value of “Current” is 12, since the current value is the maximum of color gain, the flow advances to step S219 without performing any subsequent processing. If the value of “Current” is a value other than 12, the value obtained by adding an adjustment width (adjustment amount) to the current set value is set to the internal variable “PValue”in step S213. “PValue” is a set value of color gain larger than the current set value.

In step S214, it is discriminated whether “PValue” has exceeded the maximum settable value (12 in this case). If YES in step S214, 12 which is the maximum settable value in the digital video camera 1 is set to “PValue” in step S215.

In step S216, an asynchronous packet having “PValue” as a parameter is transmitted to the digital video camera 1. Upon receiving the value of “PValue”, the digital video camera 1 sets the value of color gain in the digital video camera 1 to “PValue”.

In step S217, image data output from the digital video camera 1 with the set value set in step S216 is captured and temporarily stored in the storage unit 48. The image data read out from the storage unit 48 is then displayed as an image whose color gain is set on the plus side with respect to the current image in step S218. Reference numeral 303 in FIG. 4 denotes an image with plus setting displayed in this manner.

If the color gain does not undergo plus setting in accordance with the determination result in step S212, a totally black image is displayed as the image 303.

In step S219, the value of color gain in the digital video camera 1 returns to the initial value by transmitting an asynchronous packet having “Current” as a parameter to the digital video camera 1.

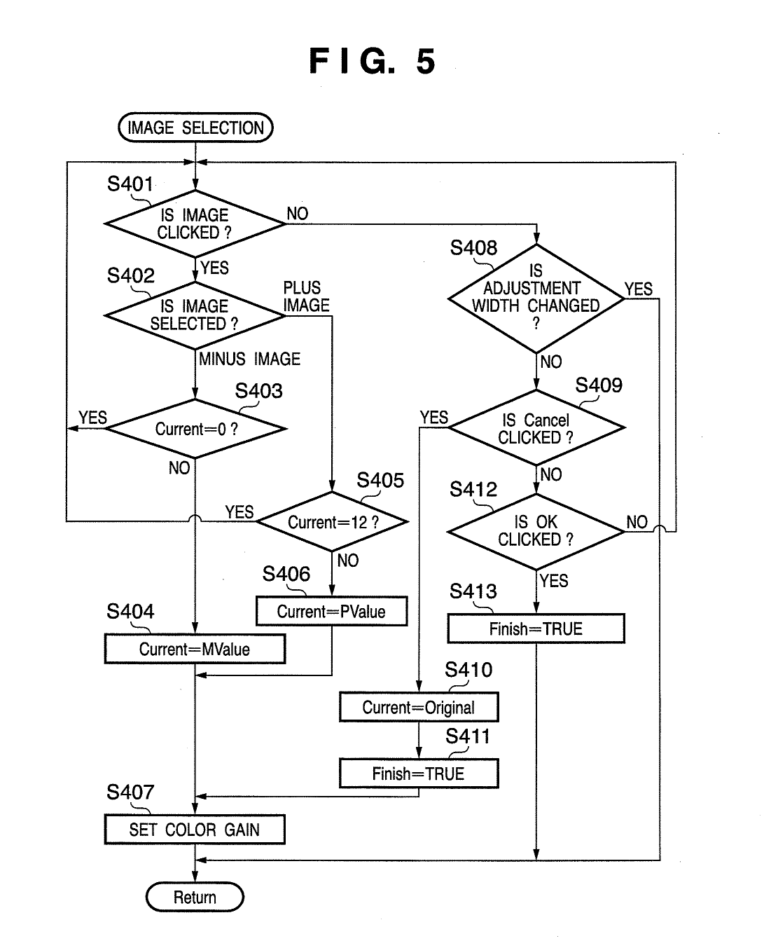

FIG. 5 is a flowchart showing detailed processing in image selection step S106 in FIG. 2.

In step S401, it is determined whether the user clicks the image 302 or 303 in FIG. 4 with the mouse of the operation unit 50. Since the user can select and click an image for which he/she thinks that appropriate image processing has been performed from the images 301 to 303 in FIG. 4, it is determined in step S401 whether this clicking operation is performed. According to this flowchart, determination is performed in accordance with mouse clicking. However, determination may be performed by other selection methods, e.g., selection by the keyboard.

If an image is clicked in step S401, the selected image is determined in step S402. If the image 302 is selected, it is determined in step S403 whether a color gain value smaller than the current set value can be set. If YES in step S403, the value of the internal variable “MValue” as a set value for the image 302 is set to the internal variable “Current” in step S404. If NO in step S403, the flow returns to step S401 without performing anything. If the image 303 is selected, it is determined in step S405 whether a color gain value larger than the current set value can be set. If YES in step S405, the value of the interval variable “PValue” as the set value of the image 303 is set to the internal variable “Current” in step S406. If NO in step S405, the flow returns to step S401 without performing anything.

After the value of the internal variable “Current” is set, an asynchronous packet having “Current” as a parameter is transmitted to the digital video camera 1 in step S407. With this operation, the value of color gain in the digital video camera 1 is set to the value set in “Current”.

When the processing shown in FIG. 5 is complete, the flow advances to step S107 in FIG. 2. Since “Finish” is kept set to “FALSE” in step S101, Finish=FALSE. For this reason, the flow returns from step S107 to step S105 to update the image display by setting the value of “Current” as the current set value. In other words, the image processed by the digital video camera 1 by using the color gain value set to “Current” is displayed at the position of an image 301 in FIG. 4.

If it is determined in step S401 in FIG. 5 that no image is clicked, it is detected in step S408 whether the adjustment width designation slider in FIG. 4 is changed. If YES in step S408, the processing shown in FIG. 5 is terminated. The flow then advances to step S107 in FIG. 2. Since Finish=FALSE, the value of “Current” is set as the current set value, and the image display is updated with the new adjustment width in step S105. In other words, the images obtained by increasing/decreasing the color gain value of the image 301 are displayed at the positions of the images 303 and 302 in FIG. 4.

If it is determined in step S408 that the adjustment width has not been changed, it is determined in step S409 whether a Cancel button 306 in FIG. 4 is clicked with the mouse or the like of the operation unit 50. The Cancel button 306 is a button which stops image processing. If the Cancel button 306 is clicked, the value of the interval variable “Original” which is a set value before the start of image processing is set to the internal variable “Current” in step S410. Thereafter, “TRUE” is set to the internal variable “Finish” in step S411.

In step S407, the color gain value of the digital video camera 1 is returned to the set value before the start of image processing by transmitting an asynchronous packet having “Current” as a parameter to the digital video camera 1. When the processing shown in FIG. 5 is complete, the flow advances to step S107 in FIG. 2, since Finish=TRUE, the image processing is terminated.

If it is determined in step S409 that the Cancel button 306 is not clicked, it is determined in step S412 whether an OK button 305 in FIG. 4 is clicked with the mouse of the operation unit 50. The OK button 305 is a button which is used to confirm and terminate image processing. If the OK button 305 is not clicked, the flow returns to step S401. If the OK button 305 is clicked, “TRUE” is set to the internal variable “Finish” in step S413.

When the processing in FIG. 5 is terminated, the flow advances to step S107 in FIG. 2 to terminate image processing because Finish=TRUE. As a consequence, the value of the internal variable “Current” is set to the value of color gain in the digital video camera 1.

As described above, according to the above embodiment, the user can receive an image with the current value and a plurality of images obtained by changing the set value and compare them on the screen of the PC 2. The user can therefore set a desired image processing parameter in the digital video camera 1 by selecting a displayed image by operating the PC 2.

The above embodiment has exemplified the case wherein the external apparatus which sets a color gain uses a personal computer. However, the present invention is not limited to this, and may be configured as a dedicated processing apparatus which sets an image processing parameter for a video camera.

Although the case wherein a color gain is adjusted as an image processing parameter has been described, an image processing parameter other than a color gain can also be adjusted by comparing an image processing result obtained using the initial value of the parameter with an image processing result obtained using a value after adjustment.

In addition, the case wherein a parameter for image processing is set in the digital camera has been described, the present invention is applicable to an image output apparatus other than a digital video camera.

### Second Embodiment

In the first embodiment, when image adjustment is performed by cooperative operation between apparatuses, software on a PC transmits an image processing request signal in which a desired parameter is set to a video camera. The video camera performs image processing for an image recoded by a camera unit in accordance with the image processing request, and transmits the image-processed video data to the PC. The software on the PC acquires the image-processed video data and displays the image on a screen. The software on the PC performs the above operation a plurality of number of times while changing a parameter to acquire a plurality of image-processed images from the video data and display them. In addition, the user can perform actual image processing by a method of selecting a desired color by referring to displayed images.

As described above, image processing can be proceeded while referring to a plurality of images by performing cooperative operation between the software on the PC and the video camera. However, it is necessary to perform the generation of an image processing request and image acquisition processing between the software on the PC and the video camera a plurality of number of times. In performing this processing, the time required between the instant the software on the PC issues an image processing request and the instant an image-processed image is acquired changes depending on the specifications of the PC and the type of video camera. A method of performing the generation of an image processing request and image display at fixed intervals can easily be executed as processing by the software. However, in order to properly perform operation in consideration of combinations of all types of PCs and video cameras, it is necessary to set sufficiently long intervals. Setting sufficiently long intervals may therefore lead to an increase in processing time.

This embodiment is directed to achieve smooth calibration between an image transmission apparatus such as a video camera and an image reception apparatus when image quality adjustment is performed by cooperative operation between the apparatuses by connecting them.

The second embodiment of the present invention will be described next.

The arrangement of an image processing system according to the second embodiment is the same as that in the first embodiment shown in FIG. 1, and hence a detailed description thereof will be omitted.

The operation of the image processing system according to the second embodiment will be described.

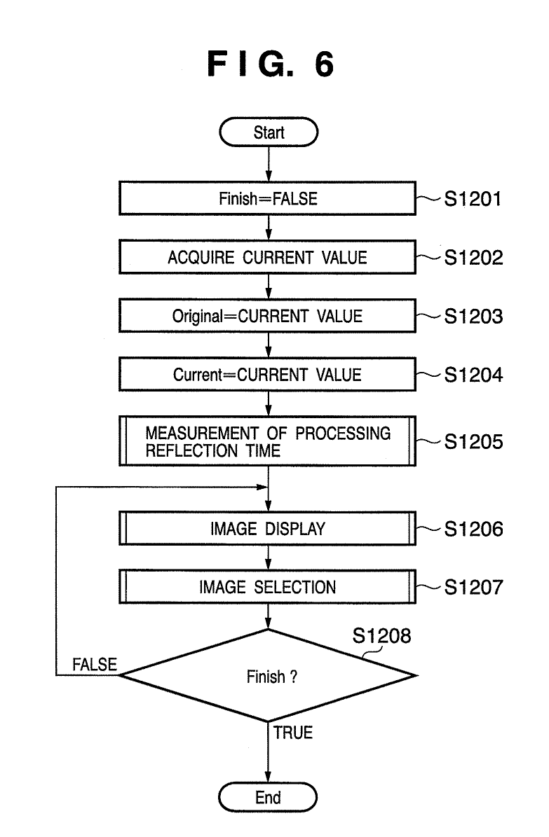

FIG. 6 is a flowchart showing an example of a processing sequence executed by software on a PC 2 in this embodiment.

First of all, in step S1201, “FALSE” is set to the internal variable “Finish”. This variable is a Boolean type variable, which indicates whether image processing operation is finished.

In step S1202, the current color gain value set in the digital video camera 1 is acquired by sending a request command. Assume that in this embodiment, the color gain can take integral values from 0 to 12, and as the value increases, color density increases. The acquisition of a color gain value uses asynchronous transaction. Software on the PC 2 transmits an asynchronous packet for the acquisition of a set value to the digital video camera 1. Upon receiving the packet, the digital video camera 1 transmits, to the PC 2, an asynchronous packet in which the current set value of color gain is set.

In steps S1203 and S1204, the set value of color gain is read out from the asynchronous packet received from the digital video camera 1, and is set to “Original” and “Current” as internal variables. Original holds the set value of color gain at the start of image processing. “Current” holds the current set value of color gain.

In step S1205, the PC 2 issues an image processing request to the digital video camera 1 by using asynchronous transaction, and measures the processing reflection time from the instant the image processing request is issued to the instant a processed image can be detected.

In step S1206, the PC 2 acquires image data output from the digital video camera 1, temporarily stores it in a storage unit 48, and displays images on the screen of a display unit 42.

In step S1207, the user selects an image displayed on the display unit 42 to determine a parameter for image processing. In this case, for example, the images displayed on the display unit 42 are a first image processed by using the current set value of color gain in the manner described later, a second image processed with a smaller color gain value, and a third image processed with a larger color gain. That the user selects an image displayed on the display unit 42 means that the user selects one of the first to third images which he/she determines to have a proper color gain value.

In step S1208, it is determined whether the image processing operation is complete. If it is discriminated that the operation is to continue, the flow returns to step S1206 to continue the processing.

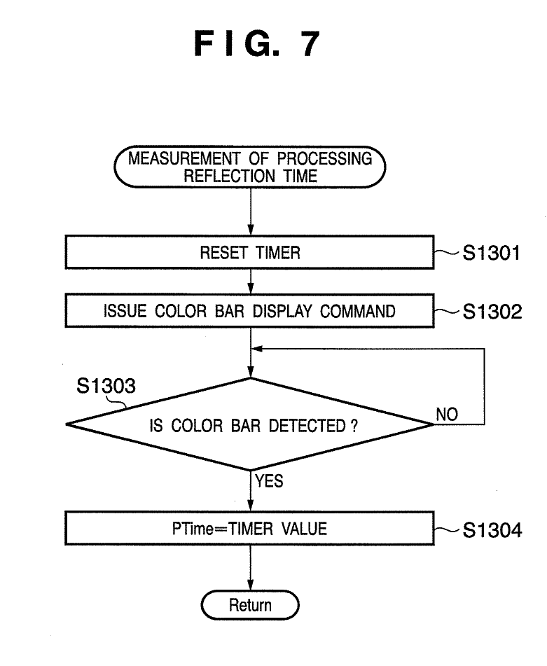

FIG. 7 is a flowchart showing an example of a detailed processing sequence for processing reflection time measurement performed in step S1205 in FIG. 6.

In step S1301, a timer managed by software on the PC 2 is reset.

In step S1302, an asynchronous packet in which a command for displaying “color bar” is set is transmitted to the digital video camera 1.

In step S1303, image data output from the digital video camera 1 is captured, and it is determined whether the captured image is a color bar image. Before the color bar display command is transmitted in step S1302, the digital video camera 1 outputs an image recorded by the camera unit. Since the color bar image is a unique still image whose predetermined data is placed at a predetermined position, the PC 2 can easily detect whether an image recorded by the camera is a color bar image, by checking whether a specific pixel on the image is a predetermined pixel value.

If it is determined in step S1303 that no color bar image is detected, step S1303 is repeated until a color bar image is detected. If it is determined in step S1303 that a color bar image is detected. The flow advances to step S1304 to set the timer value at the time of detection of the color bar to the internal variable “PTime”. “PTime” is used to hold the processing reflection time from the instant an image processing request is issued to the instant a processed image can be acquired.

In this embodiment, the processing reflection time is measured by using a color bar display command and by detecting a color bar. In some case, for example, images recorded by the camera unit of the digital video camera 1 can be output as a color image and a monochrome image, and a color image output command and a monochrome video output command are provided. In this case, when the digital video camera 1 outputs a color image, the time from the instant a monochrome video output command is transmitted to the instant a monochrome image is detected is measured. When a monochrome image is output, the time from the instant a color video output command is transmitted to the instant a color image is detected is measured. This makes it possible to measure the processing reflection time. A monochrome image and a color image can easily be detected by checking the pieces of color difference information of specific pixels on images.

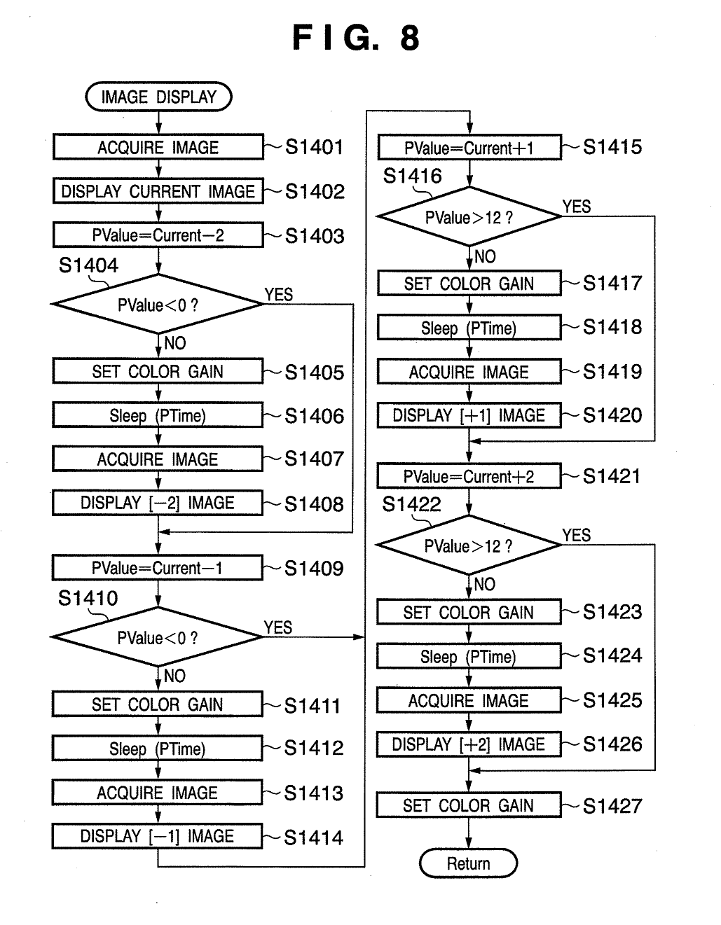

FIG. 8 is a flowchart showing an example of a detailed processing sequence for image display performed in step S1206 in FIG. 6.

In step S1401, the PC 2 captures image data output from the digital video camera 1 with the current set value, and temporarily stores it in the storage unit 48.

In step S1402, image data is read out from the storage unit 48, and an image is displayed on the screen of the display unit 42.

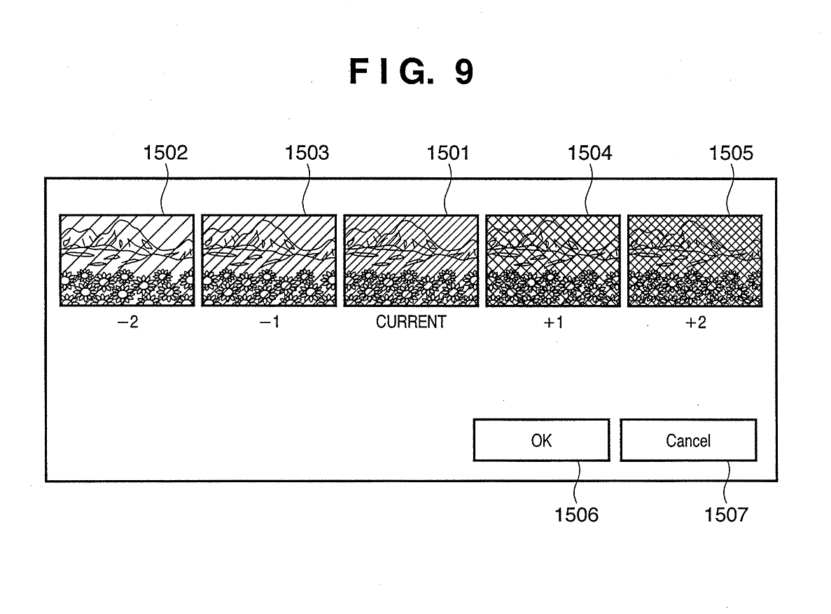

FIG. 9 is a view showing an example of a display window on the display unit 42 in this embodiment. Reference numeral 1501 denotes an image with the current set value of color gain.

The display of an image with a set value of color gain reduced by two steps from the current set value will be described.

In step S1403, a value smaller than “Current”, which is the current color gain value, by two steps is set as a color gain value after processing to the internal variable “PValue”.

In step S1404, it is determined whether the value of “PValue” is smaller than 0 which can be set. If YES in step S1404, the flow jumps to step S1409 without performing any subsequent processing.

It is determined in step S1404 that the value of “PValue” is equal to or more than 0, the flow advances to step S1405 to transmit an asynchronous packet having “PValue” as a parameter to the digital video camera 1. Upon receiving the value of “PValue”, the digital video camera 1 sets the color gain value in the digital video camera 1 to the value set in “PValue”.

In step S1406, the processing stops for the time of “PTime” measured in the flowchart of FIG. 7. When this time has elapsed, image data output from the digital video camera 1 with the set value set in step S1405 is captured and temporarily stored in the storage unit 48 in step S1407.

In step S1408, image data is read out from the storage unit 48 and is displayed on the screen of the display unit 42 as an image with its color gain value being reduced by two steps from that of the current image. Reference numeral 1502 in FIG. 9 denotes an image displayed by reducing the color gain value by two steps in this manner. If it is determined in step S1404 that the value of “PValue” is smaller than 0 which is a settable value (if the color gain is not reduced by two steps), for example, a totally black image is displayed as the second image 1502.

The display of an image obtained by reducing the set value of color gain by one step from the current set value will be described next.

In step S1409, a value smaller than “Current” as the current color gain value by one step is set as a color gain value after processing to the internal variable “PValue”.

In step S1410, it is determined whether the value of “PValue” is smaller than 0 which is a settable value. If YES in step S1410, the flow jumps to step S1415 without performing any subsequent processing.

If it is determined in step S1410 that the value of “PValue” is equal to or more than 0, the flow advances to step S1411 to transmit an asynchronous packet having “PValue” as a parameter to the digital video camera 1. Upon receiving the value of “PValue”, the digital video camera 1 sets the color gain value in the digital video camera 1 to the value set in “PValue”.

In step S1412, the processing stops for the time of “PTime” measured in the flowchart of FIG. 7. When this time has elapsed, image data output from the digital video camera 1 with the set value set in step S1411 is captured and temporarily stored in the storage unit 48 in step S1413.

In step S1414, image data is read out from the storage unit 48 and is displayed on the screen of the display unit 42 as an image with its color gain value being reduced by one step from that of the current image. Reference numeral 1503 in FIG. 9 denotes an image displayed by reducing the color gain value by one step in this manner. If it is determined in step S1410 that the value of “PValue” is smaller than 0 which is a settable value (if the color gain is not reduced by one step), for example, a totally black image is displayed as the third image 1503.

The display of an image obtained by increasing the set value of color gain by one step from the current set value will be described next.

In step S1415, a value obtained by increasing the current color gain value by one step from “Current” is set as a color gain value after processing to the internal variable “PValue”.

In step S1416, it is determined whether the value of “PValue” is smaller than 12 which is a settable value. If YES in step S1416, the flow jumps to step S1421 without performing any subsequent processing.

If it is determined in step S1416 that the value of “PValue” is equal to or less than 12, the flow advances to step S1417 to transmit an asynchronous packet having “PValue” as a parameter to the digital video camera 1. Upon receiving the value of “PValue”, the digital video camera 1 sets the color gain value in the digital video camera 1 to the value set in “PValue”.

In step S1418, the processing stops for the time of “PTime” measured in the flowchart of FIG. 7. When this time has elapsed, image data output from the digital video camera 1 with the set value set in step S1417 is captured and temporarily stored in the storage unit 48 in step S1419.

In step S1420, image data is read out from the storage unit 48 and is displayed on the screen of the display unit 42 as an image with its color gain value being increased by one step from that of the current image. Reference numeral 1504 in FIG. 9 denotes an image displayed by increasing the color gain value by one step in this manner. If it is determined in step S1416 that the value of “PValue” is smaller than 12 which is a settable value (if the color gain does not increase by one step), for example, a totally black image is displayed as the fourth image 1504.

The display of an image with a set value of color gain increased by two steps from the current set value will be described next.

In step S1421, a value larger than “Current”, which is the current color gain value, by two steps is set as a color gain value after processing to the internal variable “PValue”.

In step S1422, it is determined whether the value of “PValue” is larger than 12 which is a settable value. If YES in step S1422, the flow jumps to step S1427 without performing any subsequent processing.

If it is determined in step S1422 that the value of “PValue” is equal to or less than 12, the flow advances to step S1423 to transmit an asynchronous packet having “PValue” as a parameter to the digital video camera 1. Upon receiving the value of “PValue”, the digital video camera 1 sets the color gain value in the digital video camera 1 to the value set in “PValue”.

In step S1424, the processing stops for the time of “PTime” measured in the flowchart of FIG. 7. When this time has elapsed, image data output from the digital video camera 1 with the set value set in step S1423 is captured and temporarily stored in the storage unit 48 in step S1425.

In step S1426, image data is read out from the storage unit 48 and is displayed on the screen of the display unit 42 as an image with its color gain value being increased by two steps from that of the current image. Reference numeral 1505 in FIG. 9 denotes an image displayed by increasing the color gain value by two steps in this manner. If it is determined in step S1422 that the value of “PValue” is smaller than 12 which is a settable value (if the color gain does not increase by two steps), for example, a totally black image is displayed as the fifth image 1505.

Finally, in step S1427, an asynchronous packet having “Current” as a parameter to the digital video camera 1, and the color gain value in the digital video camera 1 is returned to the initial value.

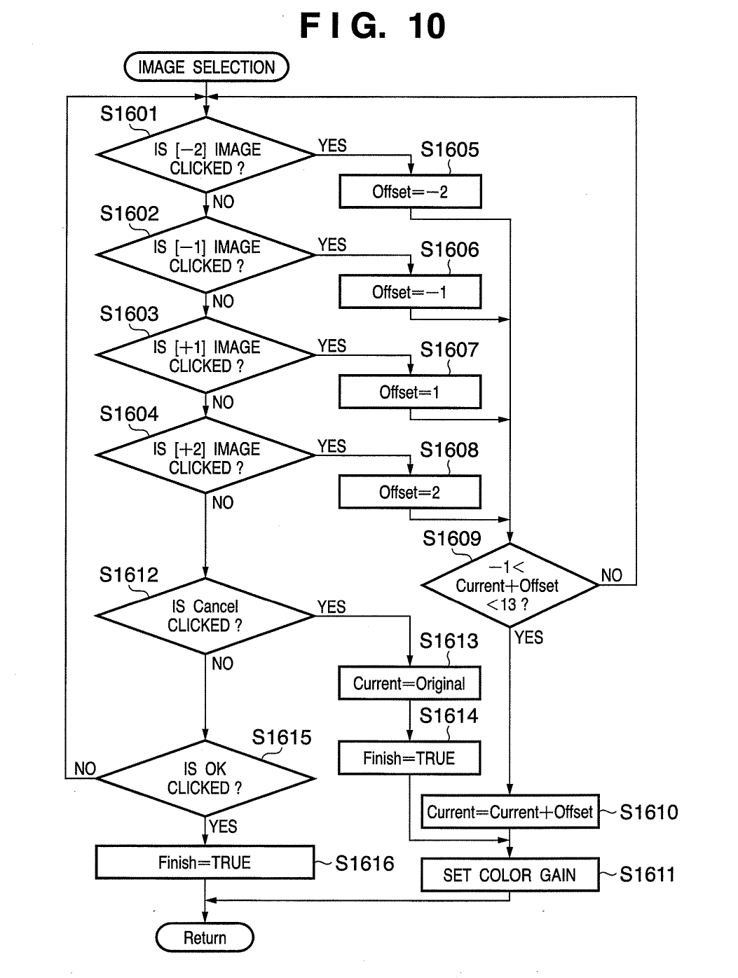

FIG. 10 is a flowchart showing an example of a detailed processing sequence for image selection in step S1207 in FIG. 6.

In steps S1601 to S1604, it is determined whether any one of second, third, fourth, and fifth images 1502, 1503, 1504, and 1505 in FIG. 9 is clicked with the mouse of an operation unit 50.

According to the processing sequence, first of all, in step S1601, it is determined whether the second image 1502 is clicked with the mouse of the operation unit 50. If NO in step S1601, the flow advances to step S1602 to determine whether the third image 1503 is clicked with the mouse of the operation unit 50. In the same manner, determination about the fourth image 1504 is performed in step S1603, and determination about the fifth image 1505 is performed in step S1604. That is, the user can select and click one of the second, third, fourth, and fifth images 1502, 1503, 1504, and 1505 in FIG. 9 for which he/she thinks that proper image processing has been done. In steps S1601 to S1604, it is checked whether such clicking operation is performed. According to this flowchart, determination is performed in accordance with mouse clicking. However, determination may be performed by other selection methods, e.g., selection by the keyboard.

If it is determined in any one of steps S1601 to S1604 that any one of the images is clicked, a difference value from the value of “Current” of the selected image is set to the internal variable “Offset” in a corresponding one of steps S1605 to S1608.

In step S1609, it is determined whether the result obtained by adding the value of “Offset” set in either of steps S1605 and S1608 to “Current” falls within the range of settable color gain values. If NO in step S1609, the flow returns to step S1601.

If it is determined in step S1609 that the result falls within the range of color gain values that can be set, the flow advances to step S1610 to set the value obtained by adding the value of “Offset” to the value of “current” as a new value of “Current”.

In step S1611, an asynchronous packet having “Current” as a parameter is transmitted to the digital video camera 1. Upon receiving the value of “Current”, the digital video camera 1 sets the color gain value in the digital video camera 1 to the value set in “Current”.

When the processing shown in FIG. 10 is complete, the flow advances to step S1208 in FIG. 6. Since “Finish” is kept set to “FALSE” in step S1201, Finish=FALSE. For this reason, the flow returns from step S1208 to step S1206 to update the image display by using the value of “Current” as a current set value. In other words, the image processed by the digital video camera 1 by using the color gain value set to “Current” is displayed at the position of the first image 1501 in FIG. 9.

If none of the second, third, fourth, and fifth images 1502, 1503, 1504, and 1505 in FIG. 9 is clicked (it is determined in step S1604 that none of these images is clicked), the flow advances to step S1612.

In step S1612, it is determined whether a Cancel button 1507 in FIG. 9 is clicked with the mouse or the like of the operation unit 50. The Cancel button 1507 is a button which stops image processing. If it is determined that the Cancel button 1507 is clicked, the flow advances to step S1613 to set the value of the internal variable “Original”, which is a set value before the start of image processing, to the internal variable “Current”.

In step S1614, “TRUE” is set to the internal variable “Finish”. In step S1611, an asynchronous packet having “Current” as a parameter is transmitted to the digital video camera to return the color gain value in the digital video camera to the set value before image processing. When the processing shown in FIG. 10 is complete, the flow advances to step S1208 in FIG. 6. Since Finish=TRUE, the image processing is terminated.

If it is determined in step S1612 that the Cancel button 1507 is not clicked, the flow advances to step S1615 to determine whether an OK button 1506 in FIG. 9 is clicked with the mouse or the like of the operation unit 50. The OK button 1506 is a button which confirms and terminates image processing. If it is determined that the OK button 1506 is not clicked, the flow returns to step S1601. If it is determined in step S1615 that the OK button 1506 is clicked, the flow advances to step S1616 to set “TRUE” to the internal variable t“Finish”.

When the processing shown in FIG. 10 is complete, the flow advances to step S1208 in FIG. 6. Since Finish=TRUE, the image processing is terminated. As a consequence, the value of the internal variable “Current” is set to the value of color gain in the digital video camera 1.

As described above, according to the second embodiment, when the display unit of the personal computer display a plurality of images, the optimal timings of the generation of an image processing request and image display can be automatically determined. This makes it possible to smoothly display a plurality of images without any wasteful waiting time. Using the plurality of displayed images allows the user to compare the image based on the current value with the plurality of images obtained by changing the set value. The user can therefore set a desired image processing parameter in the digital video camera 1 by selecting one of the displayed images.

The second embodiment has exemplified the case wherein the personal computer is used as an external apparatus which sets a color gain. However, the present invention is not limited to this, and may be configured as a dedicated processing apparatus which sets an image processing parameter for a video camera.

Although the case wherein a color gain is adjusted as an image processing parameter has been described, an image processing parameter other than a color gain is also adjustable by comparing an image processing result obtained with the initial value of the parameter with an image processing result obtained with a value after adjustment. In addition, the case wherein a parameter for image processing is set in the digital camera has been described, the present invention is applicable to an image output apparatus other than a digital video camera.

According to the second embodiment described above, the image reception apparatus includes the unit which converts each image processing parameter into a command and measures the processing reflection time from the instant the command is transmitted to the instant a corresponding image is detected, and the unit which adjusts at least one of the transmission timing of the image processing parameter and the display timing of the image on the basis of the processing reflection time. This arrangement can achieve smooth calibration between an image transmission apparatus such as a video camera and an image reception apparatus when image quality adjustment is performed by cooperative operation between the apparatuses by connecting them.

### Other Embodiment

The object of each embodiment is also achieved by the following method. A storage medium (or a recording medium) storing software program codes for implementing the functions of the above embodiments is supplied to a system or apparatus. The computer (or a CPU or an MPU) of the system or apparatus reads out and executes the program codes stored in the storage medium. In this case, the program codes read out from the storage medium implement the functions of the above embodiments by themselves, and the storage medium storing the program codes constitutes the present invention.

The functions of the above embodiments are implemented not only when the readout program codes are executed by the computer but also when the operating system (OS) or the like running on the computer performs part or all of actual processing on the basis of the instructions of the program codes.

The present invention also incorporates the following. The program codes read out from the storage medium are written in the memory of a function expansion card inserted into the computer or a function expansion unit connected to the computer. The CPU of the function expansion card or function expansion unit performs part or all of actual processing on the basis of the instructions of the program codes, thereby implementing the functions of the above embodiments. When the present invention is to be applied to the above storage medium, program codes corresponding to the above sequences are stored in the storage medium.

As another method of supplying the programs, there is available a method of connecting to a homepage in the Internet by using the browser of a client computer. Each computer program itself of the present invention or a compressed file including an automatic installation function is downloaded from the homepage to a recording medium such as a hard disk, thereby supplying the programs.

Alternatively, the programs of the present invention can be supplied by dividing the program codes constituting the programs into a plurality of files, and downloading the respective files from different homepages. That is, the present invention also incorporates a WWW server which allows a plurality of users to download program files for causing the computer to implement the functions/processing of the present invention.

In addition, the functions/processing of the present invention can be implemented by encrypting the programs of the present invention, storing the encrypted data in storage media such as CD-ROMs, distributing them to users, allowing users who satisfy a predetermined condition to download key information for decryption from a homepage through the Internet, executing the encrypted programs using the key information, and allowing a computer to install the programs.

The functions of the above embodiments are implemented not only when the readout programs are executed by the computer but also when the OS or the like running on the computer performs part or all of actual processing on the basis of the instructions of the programs.

The functions of the above embodiments are also implemented when the programs read out from the storage medium are written in the memory of a function expansion board inserted into the computer or a function expansion unit connected to the computer, and the CPU of the function expansion board or function expansion unit performs part or all of actual processing on the basis of the instructions of the programs.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-249949 field on Aug. 30, 2005, 2005-265901 filed on Sep. 13, 2005 which are hereby incorporated by reference herein in their entirety.

What is claimed is:

1. An image processing system comprising an image output apparatus which outputs an image-processed image signal and an external apparatus which can display an image associated with an image signal output from said image output apparatus such that said apparatuses can communicate with each other, wherein
said image output apparatus comprises an image processing unit which performs a plurality of image processes for an image signal to be output on the basis of an image processing parameter transmitted from said external apparatus, and a first transmission unit which sequentially transmits, to said external apparatus, a plurality of image signals image-processed by the image processing unit, and
said external apparatus comprises a setting unit which sets the image processing parameter, a second transmission unit which transmits the image processing parameter to said image output apparatus, and a display unit which simultaneously displays a plurality of images associated with the plurality of image signals sequentially transmitted from said image output apparatus on a screen.

2. The system according to claim 1, wherein said external apparatus further comprises a selection unit which selects a desired image from a plurality of images displayed on the display unit, the setting unit sets a specific image processing parameter required to obtain an image selected by the selection unit, and the image processing unit in said image output apparatus performs the plurality of image processes on the basis of a plurality of image processing parameters with reference to the specific image processing parameter set by the setting unit.

3. The system according to claim 2, wherein said external apparatus changes a display state of the desired image on the display unit when the desired image is selected by the selection unit.

4. The system according to claim 1, wherein said image output apparatus further comprises a third transmission unit which transmits the image processing parameter, set as an initial state in said image output apparatus, to said external apparatus as an initial parameter.

5. The system according to claim 4, wherein said external apparatus further comprises a storage unit which stores the initial parameter transmitted from said image output apparatus.

6. The system according to claim 5, wherein said external apparatus transmits an initial parameter stored in the storage unit to said image output apparatus when processing by said external apparatus is to stop, and said image output apparatus sets the initial parameter as a parameter for performing image processing.

7. The system according to claim 1, wherein the setting unit further comprises an adjustment amount changing unit which can change an adjustment amount of an image processing parameter for performing the plurality of image processes when the image processing parameter is set.

8. The system according to claim 1, wherein
said image output apparatus further comprises an image sensing unit, and
the image processing unit continuously performs each image process included in the plurality of image processes for a sensed image signal generated by the image sensing unit.

9. A method of controlling an image processing system comprising an image output apparatus which outputs an image-processed image signal and an external apparatus which can display an image associated with an image signal output from the image output apparatus, comprising:
a setting step of setting an image processing parameter in the external apparatus;
a first transmission step of transmitting the image processing parameter from the external apparatus to the image output apparatus;
an image processing step of performing a plurality of image processes for an image signal to be output from the image output apparatus on the basis of an image processing parameter transmitted from the external apparatus to the image output apparatus;
a second transmission step of sequentially transmitting a plurality of image signals image-processed in the image processing step from the image output apparatus to the external apparatus; and
a display step of simultaneously displaying, on a screen, a plurality of images associated with the plurality of image signals sequentially transmitted from the image output apparatus to the external apparatus.

10. The method according to claim 9, further comprising a selection step of selecting a desired image from a plurality of images displayed in the display step,
wherein in the setting step, a specific image processing parameter required to obtain an image selected in the selection step is set, and in the image processing step, the plurality of image processes are performed on the basis of a plurality of image processing parameters with reference to the specific image processing parameter set in the setting step.

11. The method according to claim 10, wherein in the selection step, when the desired image is selected, a display state of the desired image in the display step is changed.

12. The method according to claim 9, further comprising a third transmission step of transmitting the image processing parameter, set as an initial state in the image output apparatus, to the external apparatus as an initial parameter.

13. The method according to claim 12, further comprising a storage step of storing the initial parameter transmitted from the image output apparatus to the external apparatus.

14. The method according to claim 13, wherein when processing by the external apparatus is to stop, an initial parameter stored in the storage step is transmitted to the image output apparatus, and the initial parameter is set as a parameter for performing image processing in the image output apparatus.

15. The method according to claim 9, further comprising an adjustment amount changing step of, when the image processing parameter is set in the setting step, changing an adjustment amount of the image processing parameter for performing the plurality of image processes.

16. The method according to claim 9, further comprising an image sensing step,
wherein in the image processing step, each image process included in the plurality of image processes is continuously performed for a sensed image signal generated in the image sensing step.

17. A program characterized by causing a computer to execute a control method defined in claim 9.

18. A computer-readable storage medium characterized by storing a program defined in claim 17.

19. An image output apparatus which can output an image-processed image signal to an eternal apparatus, comprising:
an image sensing unit which generates a sensed image signal by sensing an object;
an image processing unit which performs a plurality of image processes for the sensed image signal output from said image sensing unit on the basis of an image processing parameter transmitted from an external apparatus which can communicate with the image output apparatus; and
a transmission unit which sequentially transmits a plurality of image signals image-processed by said image processing unit to the external apparatus.

20. An external apparatus which can communicate with an image output apparatus which outputs an image-processed image signal, comprising:
a setting unit which sets an image processing parameter different from an image processing parameter set in the image output apparatus;
a transmission unit which transmits the different image processing parameters to the image output apparatus; and
a display unit which simultaneously displays, on a screen, a plurality of images image-processed for each of the different image processing parameters in the image output apparatus which are transmitted from the image output apparatus.

21. An image processing system in which an image transmission apparatus which outputs an image-processed image signal is connected, through a communication path, to an image reception apparatus which can display an image corresponding to an image signal output from the image transmission apparatus, wherein
the image transmission apparatus comprises a first reception unit which receives a command from the image reception apparatus, an image processing unit which performs a plurality of image processes on the basis of an image processing parameter included in a command transmitted from the image reception apparatus, and a first transmission unit which transmits a plurality of image signals image-processed by the image processing unit to the image reception apparatus,
the image reception apparatus comprises a setting unit which sets the image processing parameter, a second transmission unit which converts an image processing parameter set by the setting unit into a command and transmits the command to the image transmission apparatus, a second reception unit which receives an image signal from the image transmission apparatus, and a display unit which simultaneously displays, on a screen, a plurality of images corresponding to the plurality of image signals transmitted from the image transmission apparatus, and
the image reception apparatus further comprises a processing reflection time measuring unit which measures a processing reflection time from the instant the command is transmitted to the instant a corresponding image is detected, and an adjustment unit which adjusts at least one of a transmission timing of the image processing parameter and a display timing of an image on the basis of the processing reflection time.

22. The system according to claim 21, wherein
the first transmission unit can further output a fixed pattern image,
the second transmission unit transmits a command for causing the image transmission apparatus to output the fixed pattern image, and
the processing reflection time measuring unit measures a time from the instant a command for outputting the fixed pattern image is transmitted to the instant the fixed pattern image is detected.

23. The system according to claim 22, wherein the fixed pattern image is a color bar.

24. The system according to claim 21, wherein
the first transmission unit can further output a color image and monochrome image,
the second transmission unit transmits a command for causing the image transmission apparatus to output the monochrome image while the color image is received, and
the processing reflection time measuring unit measures a time from the instant a command for outputting the monochrome image is transmitted to the instant the monochrome image is detected.

25. The system according to claim 21, wherein
the first unit can further output a color image and a monochrome image,
the second transmission unit transmits a command for causing the image transmission apparatus to output the color image when the monochrome image is received, and
the processing reflection time measuring unit measures a time from the instant a command for outputting the color image is transmitted to the instant the color image is detected.

26. An image reception apparatus which is connected to an external image transmission apparatus through a communication path and can display an image corresponding to an image signal output from the image transmission apparatus, comprising:
a setting unit which sets an image processing parameter for the image transmission apparatus;
a second transmission unit which converts an image processing parameter set by said setting unit into a command and transmits the command to the image transmission apparatus;
a second reception unit which receives a plurality of image signals output from the image transmission apparatus in accordance with the command;
a display unit which simultaneously displays a plurality of images corresponding to the plurality of image signals transmitted from the image transmission apparatus;
a processing reflection time measuring unit which measures a processing reflection time from the instant the command is transmitted to the instant a corresponding image is detected; and
an adjustment unit which adjusts at least one of a transmission timing of the image processing parameter and a display timing of an image on the basis of the processing reflection time.

27. A control method for an image processing system in which an image transmission apparatus which outputs an image-processed image signal is connected, through a communication path, to an image reception apparatus which can display an image corresponding to an image signal output from the image transmission apparatus, wherein
a control method for the image transmission apparatus comprises a first reception step of receiving a command from the image reception apparatus, an image processing step of performing a plurality of image processes on the basis of an image processing parameter included in a command transmitted from the image reception apparatus, and a first transmission step of transmitting a plurality of image signals image-processed in the image processing step to the image reception apparatus,
a control method for the image reception apparatus comprises a setting step of setting the image processing parameter, a second transmission step of converting an image processing parameter set in the setting step into a command and transmitting the command to the image transmission apparatus, a second reception step of receiving an image signal from the image transmission apparatus, and a display step of simultaneously displaying, on a screen, a plurality of images corresponding to the plurality of image signals transmitted from the image transmission apparatus, and
the control method for the image reception apparatus further comprises a processing reflection time measuring step of measuring a processing reflection time from the instant the command is transmitted to the instant a corresponding image is detected, and an adjustment step of adjusting at least one of a transmission timing of the image processing parameter and a display timing of an image on the basis of the processing reflection time.

28. The method according to claim 27, wherein
in the first transmission step, a fixed pattern image can be further output,
in the second transmission step, a command for causing the image transmission apparatus to output the fixed pattern image is transmitted, and
in the processing reflection time measuring step, a time from the instant a command for outputting the fixed pattern image is transmitted to the instant the fixed pattern image is detected is measured.

29. The method according to claim 27, wherein the fixed pattern image is a color bar.

30. The method according to claim 27, wherein
in the first transmission step, a color image and monochrome image can be further output,
in the second transmission step, a command for causing the image transmission apparatus to output the monochrome image is transmitted while the color image is received, and
in the processing reflection time measuring step, a time from the instant a command for outputting the monochrome image is transmitted to the instant the monochrome image is detected is measured.

31. The method according to claim 27, wherein
in the first step, a color image and a monochrome image can be further output,
in the second transmission step, a command for causing the image transmission apparatus to output the color image is transmitted when the monochrome image is received, and
in the processing reflection time measuring step, a time from the instant a command for outputting the color image is transmitted to the instant the color image is detected is measured.

32. A control method for an image reception apparatus which is connected to an external image transmission apparatus through a communication path and can display an image corresponding to an image signal output from the image transmission apparatus, comprising:
a setting step of setting an image processing parameter for the image transmission apparatus;
a second transmission step of converting an image processing parameter set in the setting step into a command and transmitting the command to the image transmission apparatus;
a second reception step of receiving a plurality of image signals output from the image transmission apparatus in accordance with the command;
a display step of simultaneously displaying, on a screen, a plurality of images corresponding to the plurality of image signals transmitted from the image transmission apparatus;
a processing reflection time measuring step of measuring a processing reflection time from the instant the command is transmitted to the instant a corresponding image is detected; and
an adjustment step of adjusting at least one of a transmission timing of the image processing parameter and a display timing of an image on the basis of the processing reflection time.

33. A computer program characterized by causing a computer to execute a control method defined in claim 27.

34. A computer-readable storage medium characterized by storing a computer program defined in claim 33.
